(19) United States
(12) Patent Application Publication
(10) Pub. No.: US 2003/0052971 A1
(43) Pub. Date: Mar. 20, 2003

(54) Intelligent quad display through cooperative distributed vision

(75) Inventors: Srinivas Gutta, Buchanan, NY (US); Miroslav Trajkovic, Ossining, NY (US); Vasanth Philomin, Hopewell Junction, NY (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/953,642

(22) Filed: Sep. 17, 2001

(51) Int. Cl. H04N 7/18

(52) U.S. Cl. 348/159; 348/169

(57) ABSTRACT

System and method for adjusting the position of a displayed image of a person. The system comprises a control unit that receives a sequence of images and processes the received images to determine whether the person is positioned at the border of the received images to be displayed. If so positioned, the control unit generates control signals to control the position of an optical device providing the sequence of images so that the person is positioned entirely within the image.

### FIELD OF THE INVENTION

The invention relates to quad displays and other displays that display multiple video streams on a single display.

### BACKGROUND OF THE INVENTION

A portion of a video system that is used with a quad display is represented in FIG. 1. In FIG. 1, four cameras C1-C4 are depicted as providing video surveillance of room R. Room R is depicted as having a substantially square floor space, and cameras C1-C4 are each located at a separate corner of the room R. Each camera C1-C4 captures images that lie within the camera's field of view (FOV1-FOV4, respectively), as shown in FIG. 1.

It is noted that, typically, cameras C1-C4 will be located in the corners of the room close to the ceiling and pointed downward and across the room to capture images. However, for ease of description, the representation and description of the fields of view FOV1-FOV4 for cameras C1-C4 are limited to two-dimensions corresponding to the plane of the floor, as shown in FIG. 1. Thus cameras C1-C4 may be considered as being mounted closer to the floor and pointing parallel to the floor across the room.

In FIG. 1, a person P is shown located in a position near the edges of the fields of view FOV1, FOV2 for cameras C1, C2, entirely within FOV3 for camera C3 and outside of FOV4 for C4. Referring to FIG. 2, the images of the person P in the quad display D1-D4 are shown. The displays D1-D4 correspond to cameras C1-C4. As noted, half of the front of person P is shown in display D1 (corresponding to C1) and half of the back of the person P is shown in display D2 (corresponding to C2). The back of person P is completely visible in the center of D3 (corresponding to C3) and there is no image of P visible in D4 (corresponding to C4).

A difficult with the prior art quad display system is evident in FIGS. 1 and 2. As seen, the person P so positioned may reach across his body with his right hand to put an item in his left pocket, without his hand and item being depicted in any one of the four displays. Thus, a person P may position himself in certain regions of the room and shoplift without the theft being observable on any one of the displays. A skilled thief can readily determine how to position himself just by assessing the fields of view of the cameras in the room. Moreover, even if the person P does not meticulously position himself so that the theft itself cannot be observed on one of the cameras, a skilled thief can normally position himself so that his images are split between two cameras (such as cameras C1 and C2 for displays D1 and D2). This can create a sufficient amount of confusion to the person monitoring the displays regarding which display to watch to enable the thief to put something in his or her pocket, bag, etc. without detection.

### SUMMARY OF THE INVENTION

It is thus an objective of the invention to provide a system and method for detecting persons and objects using a multiplicity of cameras and displays that accommodates and adjusts when a partial image is detected, so that at least one complete frontal image of the person is displayed.

Accordingly, the invention comprises, among other things, a system for adjusting the position of a displayed image of a person. The system comprises a control unit that receives a sequence of images and processes the received images to determine whether the person is positioned at the border of the received images to be displayed. If so positioned, the control unit generates control signals to control the position of an optical device providing the sequence of images so that the person is positioned entirely within the image. The control unit may determine that the person is positioned at the border of the received images by identifying a moving object in the sequence of image as the person and tracking the person's movement in the sequence of images to the border of the image.

In addition, the control unit may receive two or more sequences of images from two or more respective optical devices, where the optical devices are positioned so that regions of the respective two or more sequences of images overlap and the two or more sequences of images are separately displayed (as in, for example, a quad display). For each of the two or more sequences of images, the control unit processes received images of the sequence to determine whether the person is positioned at a border of the received images. Where the control unit determines that the person is positioned at the border of the received images for at least one of the two or more sequences of images, the control unit generates control signals to control the position of the optical device for the respective sequence of images, so that the entire image is displayed.

The invention also includes a method of adjusting the position of a displayed image of a person. First, a sequence of images is received. Next, it is determined whether the person is positioned at the border of the received images to be displayed. If so, the position of an optical device providing the sequence of, images is adjusted so that the person is positioned entirely within the image.

In another method included within the scope of the invention, two or more sequence of images are received. It is determined whether the person is visible in whole or in part in each of the received sequences of images to be displayed. Where the person is determined to be partially visible in one or more of the received sequences of images to be displayed, at least one optical device providing the corresponding one of the one or more received sequences of images is adjusted so that the person is positioned entirely within the received images.

### BRIEF DESCRIPTION OF THE DRAWINGS

FIG. 1 is a representation of a cameras positioned within a room that provides a quad display;

FIG. 2 is a quad display of a person as positioned in the room shown in FIG. 1;

FIG. 3a is a representation of cameras positioned within a room that are used in an embodiment of the invention;

FIG. 3b is a representation of a system of an embodiment of the invention that incorporates the cameras as positioned in FIG. 3a;

FIGS. 3c and 3d are quad displays of a person as positioned in the room of FIG. 3a with the cameras adjusted by the system of FIG. 3b in accordance with an embodiment of the invention.

### DETAILED DESCRIPTION

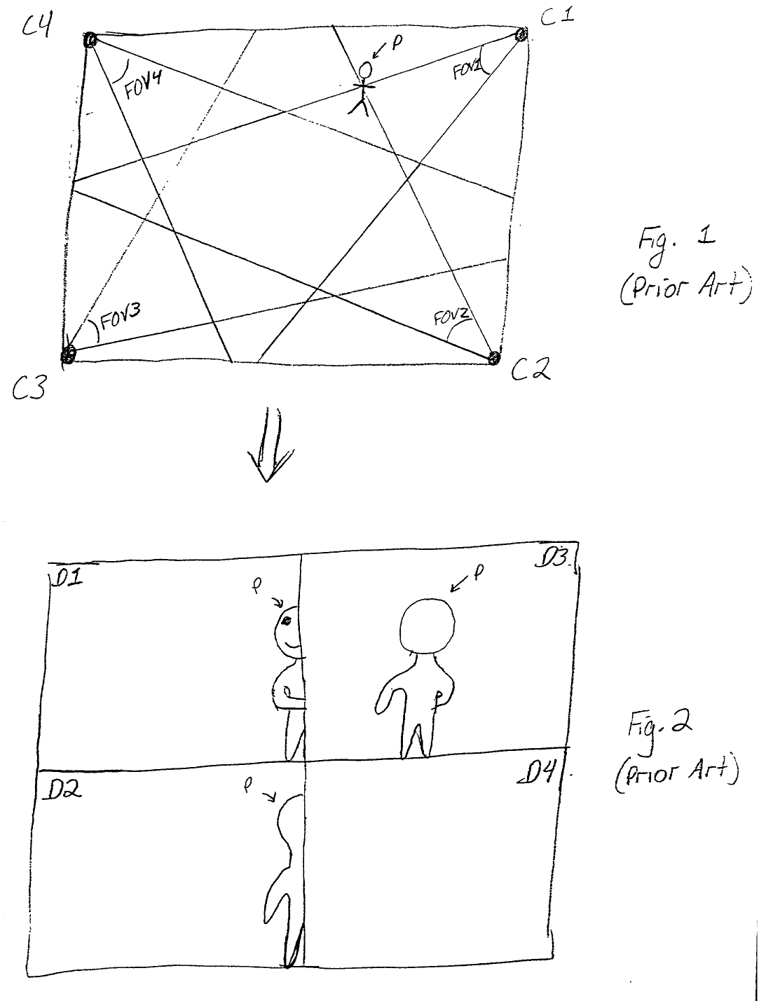

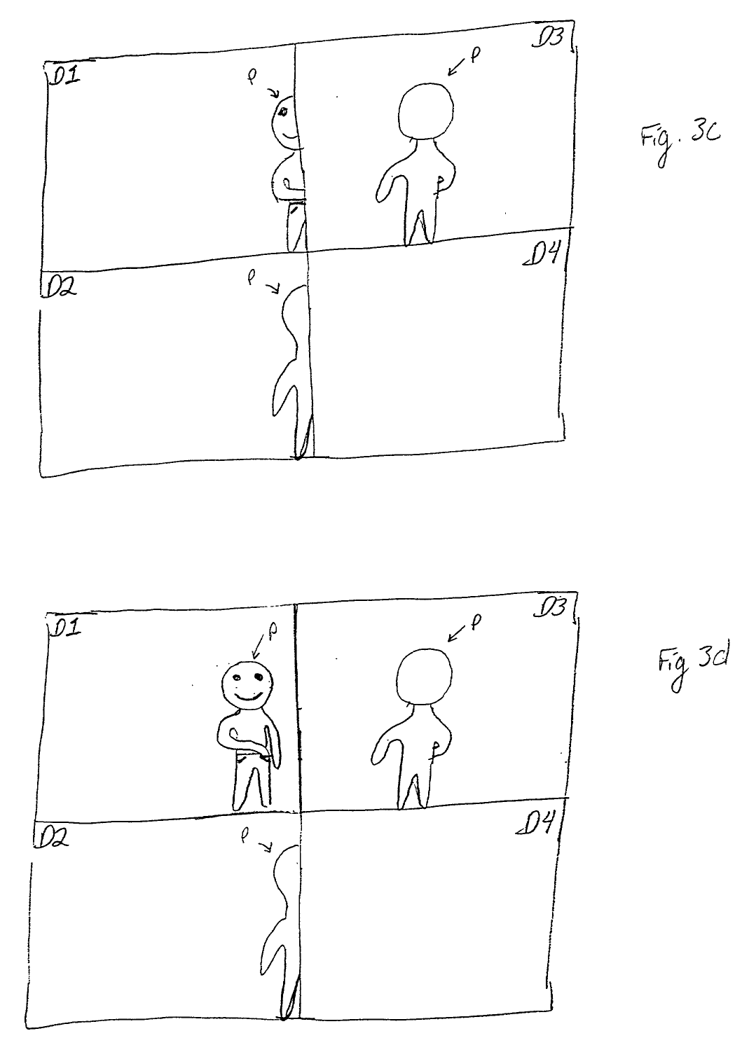

Referring to FIG. 3a, a portion of an embodiment of a system 100 of the present invention is shown. FIG. 3a shows four cameras C1-C4 having fields of view FOV1-FOV4 positioned in the four corners of a room, similar to the four cameras of FIG. 1. The two-dimensional description will also be focused upon in the ensuing description, but one skilled in the art may readily adapt the system to three dimensions.

FIG. 3b depicts additional components of the system 100 that are not shown in FIG. 3a. As seen, each camera C1-C4 is mounted on a stepper motor S1-S4, respectively. The stepper motors S1-S4 allow the cameras C1-C4 to be rotated about their respective central axes (A1-A4, respectively). Thus, for example, stepper motor C1 can rotate camera C1 through an angle ø so that FOV1 is defined by the dashed lines in FIG. 3a. The axes A1-A4 project out of the plane of the page in FIG. 3a, as represented by axis A1.

Stepper motors S1-S4 are controlled by control signals generated by control unit 110 which, may be, for example, a microprocessor or other digital controller. Control unit 110 provides control signals to stepper motors S1-S4 over lines LS1-LS4, respectively. The amount of rotation about axes A1-A4 determines the positions of the optic axes (OA1-OA4, respectively, in FIG. 3a) of the cameras C1-C4, respectively. Since the optic axes OA1-OA4 bisects the respective fields of view FOV1-FOV4 and are normal to axes A1-A4, such rotation of the respective optic axis OA1-OA4 about the axis of rotation A1-A4 effectively determines the region of the room covered by the fields of view FOV1-FOV4 of cameras C1-C4. Thus, if a person P is positioned at the position shown of FIG. 3a at the border of the original FOV1, for example, control signals from the control unit 110 to stepper motor S1 that rotate camera C1 through angle ø about axis A1 will position the person completely within FOV1 (depicted as FOV1′ in FIG. 3a). Cameras C2-C4 may be similarly controlled to rotate about axes A2-A4, respectively, by stepper motors S2-S4, respectively.

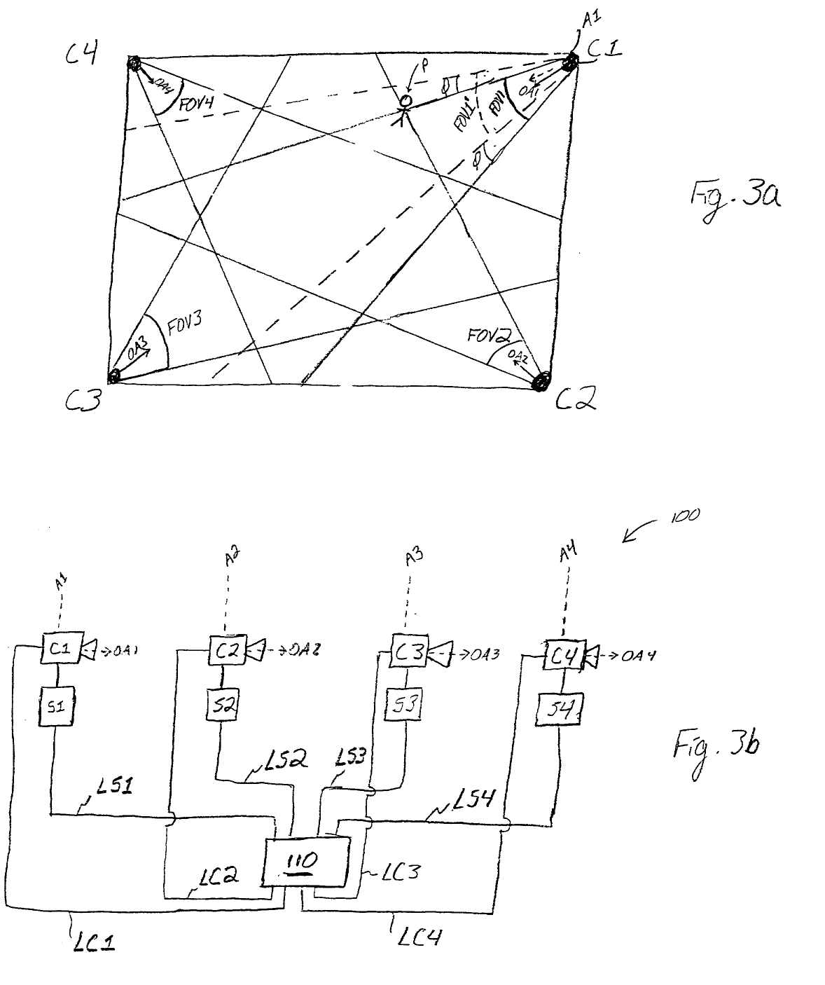

Referring back to FIG. 3a, it is seen that, with the fields of view FOV1-FOV4 of cameras C1-C4 in the positions shown, person P will be depicted in corresponding quad displays as shown in FIG. 3c. The initial position of P in the fields of view and displays are analogous to FIG. 2 discussed above. For the depiction of FIG. 3c, camera C1 is in its original (non-rotated) position, where person P is on the border of FOV1. Thus, only one-half of the front image of person P is shown in display D1 for camera C1. In addition, person P is on the border of FOV2, so only one-half of the back image of person P is shown in display D2 for camera C2. Camera C3 captures the entire back image of P, as shown in display D3. Person P lies completely out of the FOV4 of C4; thus, no image of person P appears on display D4.

When control unit 110 signals stepper motor S1 to rotate camera C1 through angle ø about axis A1 so that the field of view FOV′ of camera C1 is FOV′ completely captures person P as shown in FIG. 3a and described above, then the entire front image of person P will be displayed on display D1, as shown in FIG. 3d. By so rotating camera C1, the image of person P putting an item in his front pocket is clearly depicted in display D1.

Such rotation of the one or more of the cameras C1-C4 to adjust for a divided or partial image is determined by the control unit 110 by image processing of the images received from cameras C1-C4 over data lines LC1-LC4, respectively. The images received from the cameras are processed initially to determine whether an object of interest, such as a human body, is only partially shown in one or more of the displays. In the ensuing description, the emphasis will be on a body that is located at the edge of the field of view of one or more of the cameras and thus only partially appears at the edge of the corresponding display, such as for cameras D1 and D2 shown in FIG. 3c.

Control unit 110 may be programmed with various image recognition algorithms to detect a human body and, in particular, to recognize when an image of a human body is partially displayed at the edge of a display (or displays) because the person is at the border of the field of view of a camera (or cameras). For example, for each video stream received, control unit 110 may first be programmed to detect a moving object or body in the image data and to determine whether or not each such moving object is a human body.

A particular technique that may be used for programming such detection of motion of objects and subsequent identification of a moving object as a human body is described in U.S. patent application Ser. No. 09/794,443, entitled “Classification Of Objects Through Model Ensembles” for Srinivas Gutta and Vasanth Philomin, filed Feb. 27, 2001, Attorney Docket No. US010040, which is hereby incorporated by reference herein and referred to as the “'443 application”. Thus, as described in the '443 application, control unit 110 analyzes each of the video datastreams received to detect any moving objects therein. Particular techniques referred to in the '443 application for detecting motion include a background subtraction scheme and using color information to segment objects.

Other motion detection techniques may be used. For example, in another technique for detecting motion, values of the function S(x,y,t) are calculated for each pixel (x,y) in the image array for an image, each successive image being designated by time t:

$$S ( x , y , t ) = \frac{{\partial }^{2} G ( t )}{\partial {t}^{2}} * I ( x , y , t )$$

where G(t) is a Gaussian function and I(x,y,t) is the intensity of each pixel in image t. Movement of an edge in the image is identified by a temporal zero-crossing in S(x,y,t). Such zero crossings will be clustered in an image and the cluster of such moving edges will provide the contour of the body in motion.

The clusters may also be used to track motion of the object in successive images based on their position, motion and shape. After a cluster is tracked for a small number of successive frames, it may be modeled, for example, as having a constant height and width (a “bounding box”) and the repeated appearance of the bounded box in successive images may be monitored and quantified (through a persistence parameter, for example). In this manner, the control unit 110 may detect and track an object that moves within the field of view of the cameras C1-C4. The above-described detection and tracking technique is described in more detail in “Tracking Faces” by McKenna and Gong, Proceedings of the Second International Conference on Automatic Face and Gesture Recognition, Killington, Vt., Oct. 14-16, 1996, pp. 271-276, the contents of which are hereby incorporated by reference. (Section 2 of the aforementioned paper describes tracking of multiple motions.)

After a moving object is detected by control unit 110 in a datastream and the tracking of the object is initiated, the control unit 110 determines whether or not the object is a human body. The control unit 110 is programmed with one of a number of various types of classification models, such as a Radial Basis Function (RBF) classifier, which is a particularly reliable classification model. The '443 application describes an RBF classification technique for identification of human bodies that is used in the preferred embodiment for programming the control unit 110 to identify whether or not a detected moving object is a human body.

In short, the RBF classifier technique described extracts two or more features from each detected moving object. Preferably, the x-gradient, y-gradient and combined xy-gradient are extracted from each detected moving object. The gradient is of an array of samples of the image intensity given in the video datastream for the moving body. Each of the x-gradient, y-gradient and x-y-gradient images are used by three separate RBF classifiers that give separate classification. As described further below, this ensemble of RBF (ERBF) classification for the object improves the identification.

Each RBF classifier is a network comprised of three layers. A first input layer is comprised of source nodes or sensory units, a second (hidden) layer comprised of basis function (BF) nodes and a third output layer comprised of output nodes. The gradient image of the moving object is fed to the input layer as a one-dimensional vector. Transformation from the input layer to the hidden layer is non-linear. In general, each BF node of the hidden layer, after proper training using images for the class, is a functional representation of one of a common characteristic across the shape space of the object classification (such as a human body). Thus, each BF node of the hidden layer, after proper training using images for the class, transforms the input vector into a scalar value reflecting the activation of the BF by the input vector, which quantifies the amount the characteristic represented by the BF is found in the vector for the object under consideration.

The output nodes map the values of the characteristics along the shape space for the moving object to one or more identification classes for an object type and determines corresponding weighting coefficients for the moving object. The RBF classifier determines that a moving object is of the class that has the maximum value of weighting coefficients. Preferably, the RBF classifier outputs a value which indicates the probability that the moving object belongs to the identified class of objects.

Thus, the RBF classifier that receives, for example, the x-gradient vector of the moving object in the videostream as input will output the classification determined for the object (such as a human body or other class of object) and a probability that it falls within the class output. The other RBF classifiers that comprise the ensemble of RBF classifiers (that is, the RBF classifiers for the y-gradient and the xy-gradient) will also provide a classification output and probability for the input vectors for the moving object. The classes identified by the three RBF classifiers and the related probability are used in a scoring scheme to conclude whether or not the moving object is a human body.

If the moving object is classified as a human body, then the person is subjected to a characterizing process. The detected person is “tagged” by association with the characterization and can thereby be identified as the tagged person in subsequent images. The process of person tagging is distinct from a person recognition process in that it does not necessarily involve definitive identification of the individual, but rather simply generates an indication that a person in a current image is believed to match a person in a previous image. Such tracking of a person through tagging can be done more quickly and efficiently than repeated image recognition of the person, thus allowing control unit 110 to more readily track multiple persons in each of the videostreams from the four different cameras C1-C4.

Basic techniques of person tagging known in the art use, for example, template matching or color histograms as the characterization. A method and apparatus that provides more efficient and effective person tagging by using a statistical model of a tagged person that incorporates both appearance and geometric features is described in U.S. patent application Ser. No. 09/703,423, entitled “Person Tagging In An Image Processing System Utilizing A Statistical Model Based On Both Appearance And Geometric Features” for Antonio Colmenarez and Srinivas Gutta, filed Nov. 1, 2000 (Attorney Docket US000273), which is hereby incorporated by reference herein and referred to as the “'423 application”.

Control unit 110 uses the technique of the '423 application in the preferred embodiment to tag and track the person previously identified. Tracking a tagged person takes advantage of the sequence of known positions and poses in previous frames of the video segment. In the '423 application, the image of the identified person is segmented into a number of different regions (r=1, 2, . . . , N), such as the head, torso and legs. An image I of a video segment is processed to generate an appearance and geometry based statistical model P(I|T,ξ,Ω for a person Ω to be tagged, where T is a linear transformation used to capture global motion of the person in image 1 and ξ is a discrete variable used to capture local motion of the person at a given point in time.

As described in the '423 application, the statistical model P of the person Ω is comprised of the sum of the pixels of the person in the image I, that is, the sum of P(pix T,ξ,Ω). When the different regions r of the person are considered, the values P(pix|T,ξ,Ω) are a function of P(pix|r,T,ξ,Ω). Importantly,

P(pix|r,T,ξ,Ω)=P(x|r,T,ξ,Ω) P(f|r,T,ξ,Ω

where the pixel is characterized by its position x and by one or more appearance features f (a two-dimensional vector) representing, for example, color and texture. Thus, the tracking is performed using appearance features of the regions of the person, for example, color and texture of the pixels comprising the regions of the person.

P(x|r,T,ξ,Ω and P(f|r,T,ξ,Ω may both be approximated as Gaussian distributions over their corresponding feature spaces. The appearance features vector f can be obtained for a given pixel from the pixel itself or from a designated “neighborhood” of pixels around the given pixels. Color features of the appearance feature may be determined in accordance with parameters of well-known color spaces such as RGB, HIS, CIE and others. Texture features may be obtained using well-known conventional techniques such as edge detection, texture gradients, Gabor filters, Tamura feature filters and others.

The summation of the pixels in the image is thus used to generate the appearance and geometry based statistical model P(I|T,ξ,Ω for a person Ω to be tagged. Once generated, P(I|T,ξ,Ω is used to process subsequent images in a person tracking operation. As noted, tracking a tagged person takes advantage of the sequence of known positions and poses in previous frames of the video segment. Thus, to generate the likelihood probability of the person in a video segment comprised of a sequence of image frames, the statistical model P(I|T,ξ,Ω is multiplied with the likelihood probability of the global trajectory T of the person over the sequence (which may be charactereized by a global motion model implemented via a Kalman filter, for example) and the likelihood probability of the local motion characterized over the sequence (which may be implemented using a first order Markov model using a transition matrix).

In the above-described manner, control unit 110 identifies human bodies and tracks the various persons based on their appearance and geometrical based statistical models in each of the videostreams from each camera C1-C4. Control unit 110 will thus generate separate appearance and geometrical based statistical models for each person in each videostream received from cameras C1-C4. Since the models are based on color, texture and/or other features that will cumulatively be unique for a person, control unit 110 compares the models for the various videostreams and identifies which person identified is the same person being tracked in each of the various videostreams.

For example, focusing on one person that is present in the fields of view of at least two cameras, the person is thus identified and tracked in at least two videostreams. For further convenience, it is assumed that the one person is person P of FIG. 3a, who is walking from the center of the room toward the position shown in FIG. 3a. Thus, initially, a full image of person P is captured by cameras C1-C4. Processor P thus separately identifies person P in each videostream and tracks person P in each videostream based on separate statistical models generated. Control unit 110 compares the statistical models for P generated for the datastreams (together with the models for any other persons moving in the datastreams), and determines based on the likeness of the statistical models that person P is the same in each datastream. Control unit 110 thus associates the tracking of person P in each of the datastreams.

Once associated, control unit 110 monitors the tracking of the person P in each datastream to determine whether he moves to the border of the field of view of one or more of the cameras. For example, if person P moves from the center of the room to the position shown in FIG. 3a, then control unit 110 will track the image of P in the videostreams of cameras C1 and C2 to the border of the images, as shown in FIG. 3c. In response, control unit 110 may step the stepper motors as previously described to rotate one or more of the cameras so that the person P lies completely within the image from the camera. Thus, control unit 110 steps stepper motor S1 to rotate camera C1 clockwise (as viewed from FIG. 3a) until person P resides completely within the image from camera C1 (as shown in display D1 in FIG. 3d). Control unit 110 may also step stepper motor S2 to rotate camera C2 clockwise until person P resides completely within the image from camera C2.

As previously noted, with camera C1 rotated so that the entire front of person P is visible in FIG. 3d, the person is observed to be putting an item in his pocket. As also noted, control unit 110 may reposition all cameras (such as camera C1 and C2 for FIG. 3 a) where the tracked person P lies on the border of the fields of view. However, this may not be the most efficient for the overall operation of the system, since it is desirable that other cameras cover as much of the room as possible. Thus, where person P moves to the position shown in FIG. 3a (and displayed in FIG. 3c), control unit 110 may alternatively determine which camera is trained on the front of the person in the partial images. Thus, control unit 110 will isolate the head region of the person (which is one of the segmented regions in the tracking process) in the images from cameras C1 and C2 and apply a face recognition algorithm thereon. Face recognition may be conducted in a manner similar to the identification of the human body using the RBF network described above, and is described in detail in the “Tracking Faces” document referred to above. For the image in the videostream from C1, a match will be detected since the person P is facing the camera, whereas for C2 there will not be a match. Having so determined that person P is facing camera C1, camera C1 is rotated by control unit 110 to capture the entire image of P. In addition, to maximize the coverage of the room and reduce operator confusion, camera C2 showing part of the back side of P may be rotated counter-clockwise by control unit 110 so that person P is not shown at all.

In addition, the operator monitoring the displays may be given the option of moving the cameras in a manner that is different from that automatically performed by the control unit 110. For example, in the above example, the control unit 110 moves camera C1 so that the entire image of front side of person P is shown on display D1 (as shown in FIG. 3d) and also moves camera C2 so that the entire image of the back side of person P is removed from display D2. However, if the thief is reaching around to his back pocket with his right hand, then the image of camera C2 is more desirable. Thus, the operator may be given an option to override the movement carried out by the control unit 110. If elected, control unit 110 reverses the movement of the cameras so that the entire image of the person is captured by camera C2 and displayed on D2 and the image of the person is removed from display D1. Alternatively, the control unit 110 may move camera C2 alone so that the entire back image of the person is shown on display D2, while the entire front image remains on display D1. Alternatively, the operator may be given the option of manually controlling which camera is rotated and by how much by a manual input.

In addition, in certain circumstances (such as highly secure areas, where few people have access), the control unit 110 may adjust the positions of all cameras so that they capture a complete image of a person. Where the person is completely outside the field of view of a camera (such as camera C4 in FIG. 3a), control unit 110 may use geometric considerations (such as those described immediately below) to determine which direction to rotate the camera to capture the image.

As an alternative to the control unit 110 associating the same person in the various videostreams based upon the statistical models generated to track the persons, the control unit 110 may associate the same person using geometrical reasoning. Thus, for each camera, control unit 110 may associate a reference coordinate system with the image received from each camera. The origin of the reference coordinate system may be positioned, for example, to a point at the center of the scene comprising the image when the camera is in a reference position. When a camera is moved by the processor via the associated stepper motor, the control unit 110 keeps track of the amount of movement via a position feedback signal from the stepper motors (over lines LS1-LS4, for example) or by keeping track of the cumulative amount and directions of past and current steppings. Control unit 110 also adjusts the origin of the coordinate system so that it remains fixed with respect to the point in the scene. The control unit 110 determines the coordinate in the reference coordinate system for an identified person (for example, the center of the person's torso) in the image. As noted, the reference coordinate system remains fixed with respect to a point in the scene of the image; thus, the coordinate of the person changes as the person moves in the image and the coordinate is maintained for each person in each image by the control unit 110.

As noted, the reference coordinate system for each camera remains fixed with respect to a point in the scene comprising the image from the camera. The reference coordinate systems of each camera will typically have origins at different points in the room and may be oriented differently. However, because they are each fixed with respect to the room (or the scene of the room in each image), they may are fixed with respect to each other. Control unit 110 is programmed so that the origins and orientations of the reference coordinate systems for each camera are known with respect to the other.

Thus, the coordinate of an identified person moving in the coordinate system of a camera is translated by the control unit 110 into the coordinates for each of the other cameras. If the translated coordinates match a person identified in the videostream of one or more of the other cameras, then the control unit 110 determines that they are the same person and the tracking of the person in each datastream is associated, for the purposes described above.

Control unit 110 may use both the comparison of the statistical models in the datastreams and the geometric comparison using reference coordinate systems to determine that a person identified and tracked in the different videostreams are the same person. In addition, one may be used as a primary determination and one as a secondary determination, which may be used, for example, when the primary determination is inconclusive.

As noted, for ease of description the exemplary embodiments above relied on substantially level cameras that may be pivoted about the axes A1-A4 shown in FIG. 3b by stepper motors S1-S2. The embodiments are readily adapted to cameras that are located in the located higher in the room, for example, adjacent the ceiling. Such cameras may be PTZ (pan, tilt, zoom) cameras. The panning feature substantially performs the rotation feature of the stepper motors S1-S4 in the above embodiment. Tilting of the cameras may be performed by a second stepper motor associated with each camera that adjusts the angle of the optic axis of the cameras with respect to the axes A1-A4, thus controlling the angle at which the camera looks down on the room. Moving objects are identified as human bodies and tracked in the above-described manner from the images received from the cameras, and the camera may be both panned and tilted to capture the complete image of a person who walks to the border of the field of view. In addition, with the camera tilted, the image received may be processed by control unit 110 to account for the third dimension (depth within the room with respect to the camera) using known image processing techniques. The reference coordinate systems generated by control unit 110 for providing the geometrical relationship between objects in the different images may be expanded to include the third depth dimension. Of course, the embodiments may be readily adapted to accommodate more or less than four cameras.

The invention includes alternative ways of adjusting one or more cameras so that a person standing at the border of a field of view is fully captured in the image. Control unit 110 stores a series of baseline images of the room for each camera in different positions. The baseline images include objects that are normally located in the room (such as shelves, desks, computers, etc.), but not any objects that move in and out of the room, such as people (referred to below as “transitory objects”). Control unit 110 may compare images in the videostream for each with an appropriate baseline image and identify objects that are transitory objects using, for example, a subtraction scheme or by comparing gradients between the received and baseline image. For each camera, a set of one or more transitory objects is thus identified in the videostream.

Particular features of the transitory objects in each set are determined by the control unit 110. For example, the color and/or texture of the objects are determined in accordance with well-known manners described above. Transitory objects in the sets of objects from the different videostreams are identified as the same object based on a matching feature, such as matching colors and/or texture. Alternatively, or in addition, a reference coordinate system associated with the videostream for each camera as described above may be used by the control unit 110 to identify the same transitory object in each videostream based on location, as also described above.

For each object that is identified in the various datastreams as being the same, the control unit 110 analyzes the object in one or more of the datastreams further to determine whether it is a person. Control unit 110 may use an ERBF network in the determination as described above and in the '443 application. Where a person is located behind an object or at the border of the field of view of one of the cameras, control unit 110 may have to analyze the object in the datastream of a second camera.

Where the object is determined to be a person, then the control unit 110 tracks the person in the various datastreams if he is in motion. If the person is or becomes stationary, control unit 110 determines whether the person in one or more of the datastreams is obscured by another object (for example, by a column, counter, etc.) or is partially cut off due to residing at the edge of the field of view of one or more cameras. Control unit 110 may, for example, determine that the person is at the edge of the field of view by virtue of the position in the image or the reference coordinate system for the datastream. Alternatively, control unit 110 may determine that the person is obscured or at the edge of the field of view by integrating over the surface area of the person in each of the images. If the integral is less for the person in one or more of the datastreams than others, then the camera may be adjusted by the control unit 110 until the surface integral is maximized, thus capturing the entire image (or as much as possible, in the case of an object obscuring the person) in the field of view for the camera. Alternatively, where the person is at the edge of the field of view, the camera may be re-positioned so that the person lies completely outside the field of view. As previously described, the adjustment may also be made by the control unit 110 depending on a face recognition in one or more of the images, and may also be overridden by a manual input by the display operator.

The following documents are hereby incorporated herein by reference:

1) “Mixture of Experts for Classification of Gender, Ethnic Origin and Pose of Human Faces” by Gutta, Huang, Jonathon and Wechsler, IEEE Transactions on Neural Networks, vol. 11, no. 4, pp. 948-960 (July 2000), which describes detection of facial sub-classifications, such as gender and ethnicity using received images. The techniques in the Mixture of Experts paper may be readily adapted to identify other personal characteristics of a person in an image, such as age.

2) “Pfinder: Real-Time Tracking Of the Human Body” by Wren et al., M.I.T. Media Laboratory Perceptual Computing Section Technical Report No. 353, published in IEEE Transactions on Pattern Analysis and Machine Intelligence, vol. 19, no. 7, pp 780-85 (July 1997), which describes a “person finder” that finds and follows people's bodies (or head or hands, for example) in a video image

3) “Pedestrian Detection From A Moving Vehicle” by D. M. Gavrila (Image Understanding Systems, DaimlerChrysler Research), Proceedings of the European Conference on Computer Vision, Dublin, Ireland (2000) (available at www.gavrila.net), which describes detection of a person (a pedestrian) within an image using a template matching approach.

4) “Condensation—Conditional Density Propagation For Visual Tracking” by Isard and Blake (Oxford Univ. Dept. of Engineering Science), Int. J. Computer Vision, vol. 29, no. 1, pp. 5-28 (1998) (available at www.dai.ed.ac.uk/CVonline/LOCAL_COPIES/ISARD1/condensation.html, along with the “Condensation” source code), which describes use of a statistical sampling algorithm for detection of a static object in an image and a stochastical model for detection of object motion.

5) “Non-parametric Model For Background Subtraction” by Elgammal et al., 6th European Conference on Computer Vision (ECCV 2000), Dublin, Ireland, June/July 2000, which describes detection of moving objects in video image data using a subtraction scheme.

6) “Segmentation and Tracking Using Colour Mixture Models” by Raja et al., Proceedings of the 3^{rd} Asian Conference on Computer Vision, Vol. 1, pp. 607-614, Hong Kong, China, January 1998.

Although illustrative embodiments of the present invention have been described herein with reference to the accompanying drawings, it is to be understood that the invention is not limited to those precise embodiments, but rather it is intended that the scope of the invention is as defined by the scope of the appended claims.

What is claimed is:

1. A system for adjusting the position of a displayed image of a person, the system comprising a control unit that receives a sequence of images, the control unit processing the received images to determine whether the person is positioned at the border of the received images to be displayed and, when it is determined that the person is positioned at the border of the received images to be displayed, generating control signals to control the position of an optical device providing the sequence of images so that the person is positioned entirely within the image.

2. The system as in claim 1, wherein the control unit determines that the person is positioned at the border of the received images by identifying a moving object in the sequence of image as the person and tracking the person's movement in the sequence of images to the border of the image.

3. The system as in claim 2, wherein the moving object is identified as the person by processing the data for the object using an RBF network.

4. The system as in claim 2, wherein tracking the person's movement in the sequence of images includes identifying at least one feature of the person in the image and using the at least one feature to track the person in the image.

5. The system as in claim 4, wherein the at least one feature is at least one of a color and a texture of at least one region of the person in the image.

6. The system as in claim 2, wherein the control unit receives two or more sequences of images from two or more respective optical devices, the optical devices positioned so that regions of the respective two or more sequences of images overlap, the two or more sequences of images being separately displayed.

7. The system as in claim 6, wherein, for each of the two or more sequences of images, the control unit processes received images of the sequence to determine whether the person is positioned at a border of the received images.

8. The system as in claim 7, wherein, for at least one of the two or more sequences of images where the control unit determines that the person is positioned at the border of the received images, the control unit generates control signals to control the position of the optical device for the respective sequence of images so that the entire image of the person is captured.

9. The system as in claim 8, wherein the control unit generates control signals so that the optical device is moved to position the person completely within the image.

10. The system as in claim 7, wherein, for each of the two or more sequences of images, the determination by the control unit of whether the person is positioned at the border of received images of the sequence comprises identifying moving objects in the sequence of images, determining whether the moving objects are persons and tracking moving objects determined to be persons within the sequence of images.

11. The system as in claim 10, wherein the tracking of moving objects determined to be persons within each of the sequence of images further comprises identifying which persons are the same person in two or more of the sequences of images.

12. The system as in claim 11, wherein the control unit determines that the person is positioned at the border of the received images for at least one of the sequence of images by identifying the person as the same person in two or more sequences of images and tracking the person to a position at the border of at least one of the sequences of images.

13. A method of adjusting the position of a displayed image of a person, the method comprising the steps of receiving a sequence of images, determining whether the person is positioned at the border of the received images to be displayed and adjusting the position of an optical device providing the sequence of images so that the person is positioned entirely within the image.

14. The method of claim 13, wherein the step of determining whether the person is positioned at the border of the received images to be displayed comprises the step of identifying the person in the received images.

15. The method of claim 14, wherein the step of determining whether the person is positioned at the border of the received images to be displayed also comprises the step of tracking the person in the received images.

16. A method of adjusting the position of a displayed image of a person, the method comprising the steps of receiving two or more sequence of images, determining whether the person is visible in whole or in part in each of the received sequences of images to be displayed and, where the person is determined to be partially visible in one or more of the received sequences of images to be displayed, adjusting at least one optical device providing the corresponding one of the one or more received sequences of images so that the person is positioned entirely within the received images.
